(19) United States
(12) Patent Application Publication
(10) Pub. No.: US 2008/0153451 A1
(43) Pub. Date: Jun. 26, 2008

(54) RF Rx front end module for picocell and microcell base station transceivers

(76) Inventors: Thomas A. Knecht, Dundee, IL (US); Glen Reeser, Palatine, IL (US); Dean Clark, Corsham (GB)

Correspondence Address: DANIEL J. DENEUFBOURG;CTS CORPORATION, 171 COVINGTON DRIVE, BLOOMINGDALE, IL, 60108, US

(21) Appl. No.: 11/823,735

(22) Filed: Jun. 28, 2007

Related U.S. Application Data
(63) Continuation-in-part of application No. 11/452,800, filed on Jun. 14, 2006.
(60) Provisional application No. 60/819,758, filed on Jul. 7, 2006.

(51) Int. Cl. H04B 1/08

(52) U.S. Cl. 455/349

(57) ABSTRACT

An RF Rx module adapted for direct surface mounting to the top surface of the front end of the motherboard of a picocell. The module comprises a printed circuit board having a plurality of direct surface mounted discrete electrical components defining a receive (Rx) section and path for RF signals. The signal receive section is defined by at least the following elements located under a lid which is attached to the surface of the board: a duplexer, a receive low pass filter, a low-noise amplifier, and a receive bandpass filter. At least one aperture in the board is adapted to accept a screw or the like for securing the module to the motherboard of the picocell.

### CROSS-REFERENCE TO RELATED APPLICATIONS

This application is a continuation-in-part non-provisional application which claims the benefit of U.S. application Ser. No. 11/452,800, filed on Jun. 14, 2006 and U.S. Provisional application Ser. No. 60/819,758 filed on Jul. 7, 2006, the disclosures of which are explicitly incorporated herein by reference as are all references cited therein.

### FIELD OF THE INVENTION

The invention relates to a module and, more particularly, to a radio frequency Rx module adapted for use in the front end of a picocellular or microcellular communication base station.

### BACKGROUND OF THE INVENTION

There are currently three types of cellular communication base stations or systems in use today for the transmission and reception of W-CDMA and UMTS based cellular communication signals, i.e., macrocells, microcells and picocells. Macrocells, which today sit atop cellular towers, operate at approximately 1,000 watts. The coverage of macrocells is in miles. Microcells, which are smaller in size than macrocells, are adapted to sit atop telephone poles, for example, and the coverage is in blocks. Microcells operate at approximately 20 watts. A smaller yet microcell requires about 5 watts of power to operate. Picocells are base stations approximately 8″×18″ in size, are adapted for deployment inside buildings such as shopping malls, office buildings or the like, and output about 0.25 watts of power. The coverage of a picocell is about 50 yards.

All of the picocells and microcells in use today include a “motherboard” upon which various electrical components are mounted. A front-end portion of the motherboard (i.e., the RF transceiver section thereof located roughly between the picocell antenna and mixers thereof) is currently referred to in the art as the “node B local area front end,” i.e., a portion of the picocell or microcell on which radio frequency control electrical components are mounted.

The present invention provides a compact front-end RF component module which is adapted to either replace the RF Rx (receive) components that would be typically used in a Node B local area Rx (receive) path and/or complement the existing RF Rx (receive) components to provide dual Rx diversity.

### SUMMARY OF THE INVENTION

The present invention relates to a module adapted for use on the front end of a picocell or microcell base station including a printed circuit board having a plurality of discrete electrical components mounted directly thereto and adapted to allow for the reception of cellular signals between the antenna of the picocell or microcell on one end and the respective output pad on the motherboard of the picocell or microcell at the other end.

In one embodiment, the module includes at least a duplexer, a receive low pass filter, an optional attenuator pad, a low noise amplifier, and a receive bandpass filter. The duplexer, receive bandpass filter, and the low noise amplifier are all preferably located under a lid. The duplexer, receive low pass filter, and receive bandpass filter provide for the distributed filtering of the Rx cellular signals, i.e., the cellular signals being received through the picocell or microcell antenna. An aperture in the board is adapted to accept a screw or the like for securing the module to a customer's motherboard.

Other advantages and features of the present invention will be more readily apparent from the following detailed description of the preferred embodiment of the invention, the accompanying drawings, and the appended claims.

### BRIEF DESCRIPTION OF THE DRAWINGS

These and other features of the invention can best be understood by the following description of the accompanying FIGURES as follows:

FIG. 1 is a simplified block diagram depicting the flow of cellular signals through the various RF components defining the front-end Rx module of the present invention;

FIG. 2 is an enlarged perspective view of a front-end Rx module in accordance with the present invention;

FIG. 3 is an enlarged top plan view of the front-end Rx module with the lid removed therefrom;

FIGS. 4A and 4B are perspective top and bottom views respectively of the lid of the front-end Rx module of the present invention;

FIG. 5 is an enlarged bottom plan view of the front-end Rx module of the present invention;

FIG. 6 is a schematic diagram of the electrical circuit of the front-end Rx module of the present invention;

FIG. 7 is a graph of the Rx gain performance of the Rx module of the present invention; and

FIG. 8 is an enlarged simplified top plan view of the printed circuit board of the front end module of the present invention.

### DETAILED DESCRIPTION OF THE PREFERRED EMBODIMENT

While this invention is susceptible to embodiments in many different forms, this specification and the accompanying FIGURES disclose only one preferred embodiment as an example of the present invention which is adapted for use in a picocell. The invention is not intended, however, to be limited to the embodiment so described and extends, for example, to microcells as well.

In selected ones of the FIGURES, a single block or cell may indicate several individual components and/or circuits that collectively perform a single function. Likewise, a single line may represent several individual signals or energy transmission paths for performing a particular operation.

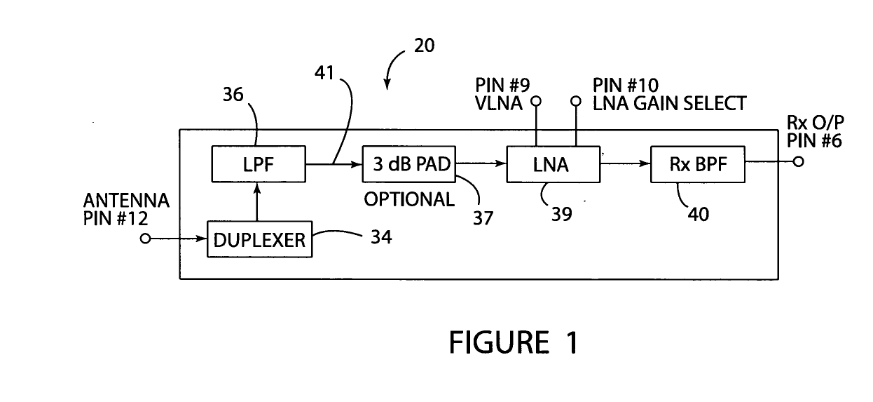

FIG. 1 is a simplified block diagram of the RF (radio frequency) front-end Rx module, generally designated 20, constructed in accordance with the present invention and adapted for use in connection with either a picocell or microcell.

As described in more detail below, the Rx module 20 utilizes distributed filtering in the Rx path (i.e., RF signal receive path) with three discrete RF filters: a duplexer 34, a low pass filter 36, and a receive bandpass filter 40. Module 20 is particularly adapted for the 3G Wideband CDMA market, specifically UMTS (Universal Mobile Telecommunications Service).

Module 20 is adapted to replace (and/or complement depending upon the desired application as disclosed in more detail below) the RF Rx components used in the Rx path of a UMTS Node B local area front end. Module 20 is compliant with TS25.104 R6 standards and allows customers to select different values for receiver sensitivity, selectivity, and output power. Moreover, module 20 is RoHS compliant and lead-free. Some of the features of the module 20 as described above and in more detail below includes a distributed filtering configuration offering excellent isolation and harmonic suppression together with a low noise amplifier which includes a bypass mode to increase receiver linearity.

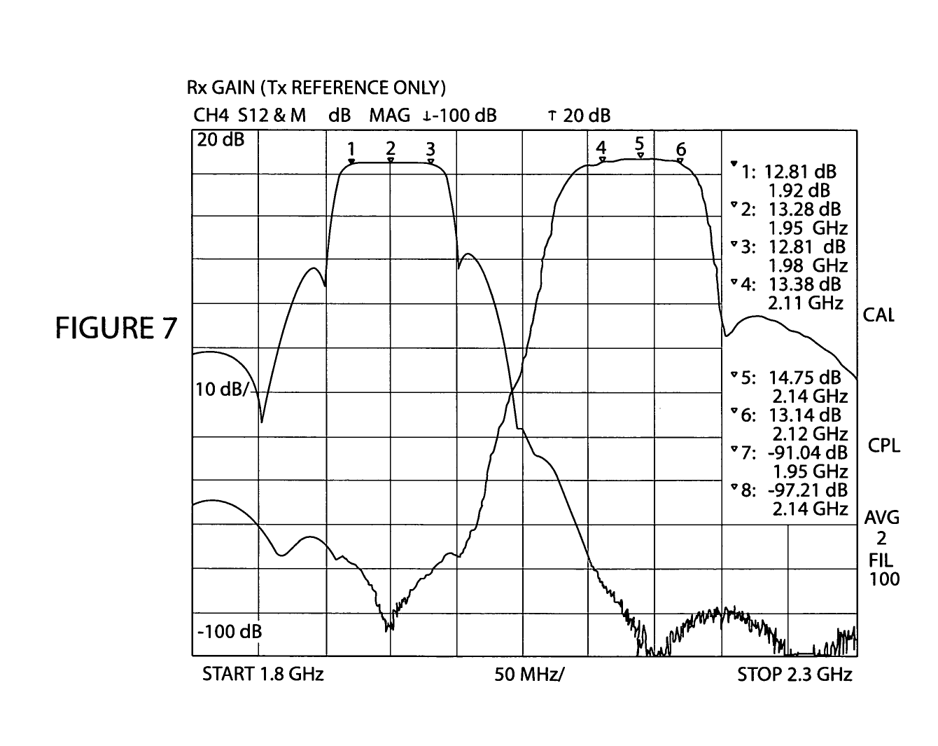

FIG. 7 depicts the Rx gain performance characteristics of the module 20 of the present invention. A summary of the basic module operational parameters providing for the performance shown in FIG. 7 follows in TABLES A-D:

TABLE A
ELECTRICAL SPECIFICATIONS
Absolute Maximum Ratings

| | Min. | Max. | Unit |
|---|---|---|---|
| Ports | | 18.6 | dBm |
| RF input power | | | |
| Operating | −40 | +85 | C. |
| Temperature | | | |
| Storage | −40 | +105 | C. |
| Temperature | | | |
| LNA Supply | | | |
| V | | 6 | V |
| I | | 32 | mA |

TABLE B
Technical Data

| | Min. | Typ. | Max. | Unit |
|---|---|---|---|---|
| RX frequency band | 1920 | | 1980 | MHz |
| LNA Supply | | | | |
| V | 4.5 | 5 | 5.5 | V |
| I | | 21 | | mA |

TABLE C
RF Performance Receive Rx Section
Overall

| | Specification | | | | Conditions |
|---|---|---|---|---|---|
| Parameter | Min. | Typ. | Max. | Unit | Notes |
| Frequency | 1920 | | 1980 | MHz | Vcc = 5 V @ 25 C. |
| High Gain | | | | | LNA Gain Select, V < 0.8 V |
| Mode | | | | | |
| Gain | 10 | 12 | 14 | dB | Rx port to antenna port note: |
| | | | | | Gain or bypass mode |
| | | | | | selectable via external |
| | | | | | control pin #10. |
| Noise Figure | | 4 | 5 | dB | |
| IIP3 | 9 | 10 | | dBm | |
| BYPASS | | | | | LNA Gain Select, V > 1.8 V |
| MODE | | | | | |
| Gain | | −9 | | dB | |
| IIP3 | 21 | 22 | | dBm | |

TABLE D
RF Performance Receive Rx Section

| | Min. | Typ. | Max. | Unit | |
|---|---|---|---|---|---|
| Antenna port | −12 | −21 | | dB | |
| return loss | | | | | |
| Tx input to Rx | 60 | 65 | | dB | 25 C. |
| output isolation | | | | | |
| Ripple | | 1.4 | | dB | 25 C. |

Out-of-Band Response

Attenuation

| Frequency | Min. | Typ. | Unit |
|---|---|---|---|
| 0-1800 MHz | 40 | 45 | dB |
| 1800-19900 MHz | 15 | 20 | dB |
| 2000-2050 MHz | 16 | 20 | dB |
| 2110-2170 MHz | 60 | 80 | dB |
| 2.17 GHz-12.75 GHz | 30 | | dB |

Referring now to FIG. 1, it is understood that module 20 is defined by a plurality of discrete RF Rx electrical components and pins defining an RF signal receive (Rx) section or path.

The receive section or path of the signals being received (i.e., Rx signals) from the picocell or microcell antenna (not shown) and transmitted through the module 20 will now be described with reference to FIG. 1 which shows the Rx signal being transmitted and passed in a left to right, clockwise direction from the picocell or microcell antenna (not shown) through the module antenna pin #12 and then initially through a duplexer 34 of the type made and sold by CTS Corporation of Elkhart, Ind.

Duplexer 34 is, of course, adapted and structured as known in the art to allow the passage of the Rx signal clockwise in the direction of the Rx LPF (low pass) filter 36. In accordance with the present invention, Rx low pass filter 36 is adapted and structured to reduce the harmonics of the duplexer 34, ensuring that any spurious responses up to 12.75 GHz are attenuated to −30 dB or better. From the low pass filter 36, the Rx signal, generally designated by the arrows 41, may optionally be passed through a 3 dB attenuator pad 37 (comprised of discrete resistors R5, R6, and R8 as described in more detail below), and then through a LNA (low noise amplifier) 39.

In accordance with the present invention, attenuator pad 37 is optional and may be used to de-sensitize the receive chain and make the receiver more linear, i.e., to decompress the receive chain when the Node B is deployed in an environment, for example, where other devices are operated in close proximity to the picocell. Where more sensitivity is desired at the expense of linearity, pad 37 may have a different value. Optionally, of course, the pad 37 can be omitted altogether. All 3GPP specifications are met even with the 3 dB-pad 37 in place.

Low noise amplifier 39 is coupled to VLNA (LNA supply voltage) pin #9 and LNA (low noise amplifier) gain select pin #10. The LNA has a noise figure of 1.3 dB and a gain of 14 dB typical, or in bypass mode; 4.3 dB NF and −3 dB gain typical. The LNA is very linear and is designed to work within the distributed duplexer architecture.

From the low-noise amplifier 39, the Rx signal then travels through an Rx BPF (receive bandpass ceramic filter) 40 of the type also made and sold by CTS Corporation of Elkhart, Ind. From the Rx bandpass filter 40, Rx signal 41 passes into Rx output signal pin #6 which, in turn, is adapted to extend between the top and bottom surfaces of the module 20 as described in more detail below for direct surface coupling to the corresponding Rx output signal pad (not shown) on the motherboard of the picocell or microcell.

In accordance with the invention, the Rx band pass filter 40 works in conjunction with the duplexer 34 to provide in excess of 80 dB receive to transmit isolation. Filter 40 additionally serves the function of providing the close-in blocking needed in order to be compliant with the TS25.104 R6 Standard. One of the most difficult aspects of the TS25.104 R6 standard is a blocking requirement that leads to a front-end attenuation of 15 dB to 20 dB at 1.9 GHz and 2 GHz.

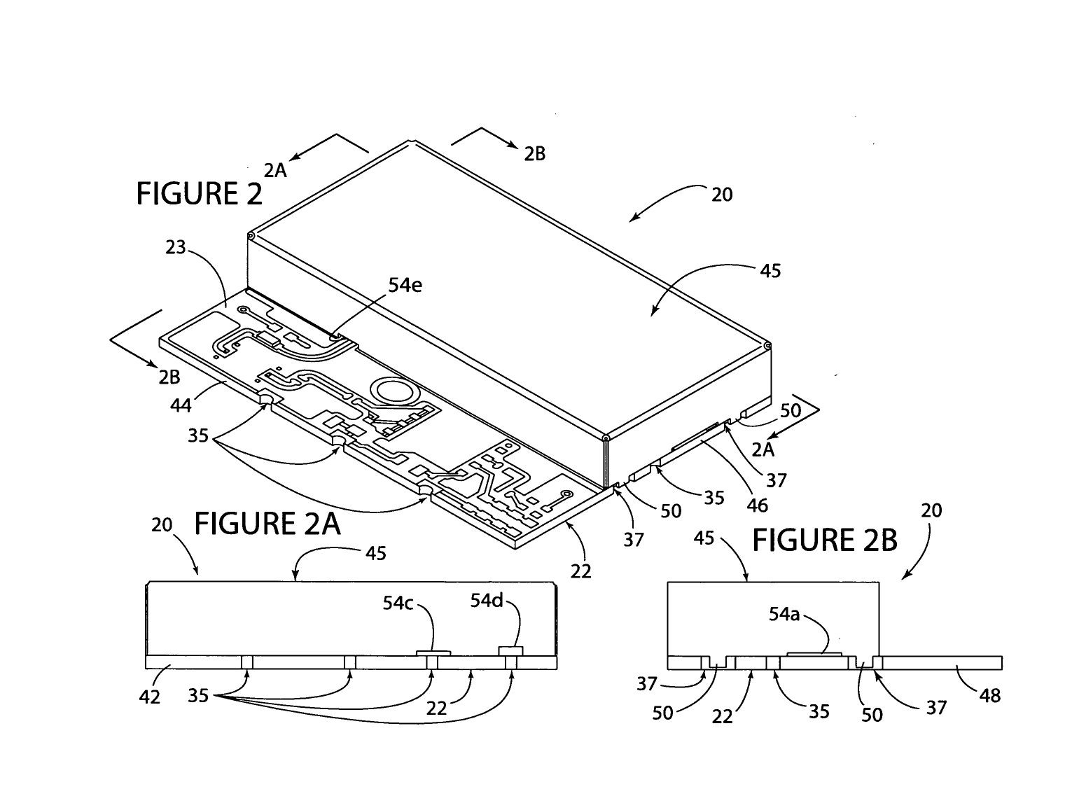

FIGS. 2-5 and 8 depict one embodiment of the module 20. By way of background, it is understood that module 20 depicted in FIG. 2 measures about 25.0 mm in width, 30.5 mm in length, and 6.75 mm max. in height (with the lid secured thereon), and is adapted to be mounted to the motherboard of a picocell measuring about 8 inches by 18 inches which, as described above, is adapted for use as a cellular signal transfer base station inside a building such as a shopping mall or office complex. The typical power output of a picocell is approximately 250 mW. The frequency of the Rx signal received by a picocell is between about 1920-1980 MHz and the low noise amplifier supply voltage is between about 4.5-5.5 volts and typically about 5.0 volts.

Module 20 initially comprises a printed circuit board or substrate 22 which, in the embodiment shown, is preferably made of four layers of GETEK® or the like dielectric material and is about 1 mm (i.e., 0.040 inches) in thickness. Predetermined regions of the substrate 22 are covered with copper or the like material and solder mask material, both of which have been applied thereto and/or selectively removed therefrom as is known in the art to create the various copper, dielectric, and solder mask regions on the substrate 22. The metallization system is preferably ENIG, electroless nickel/immersion gold over copper.

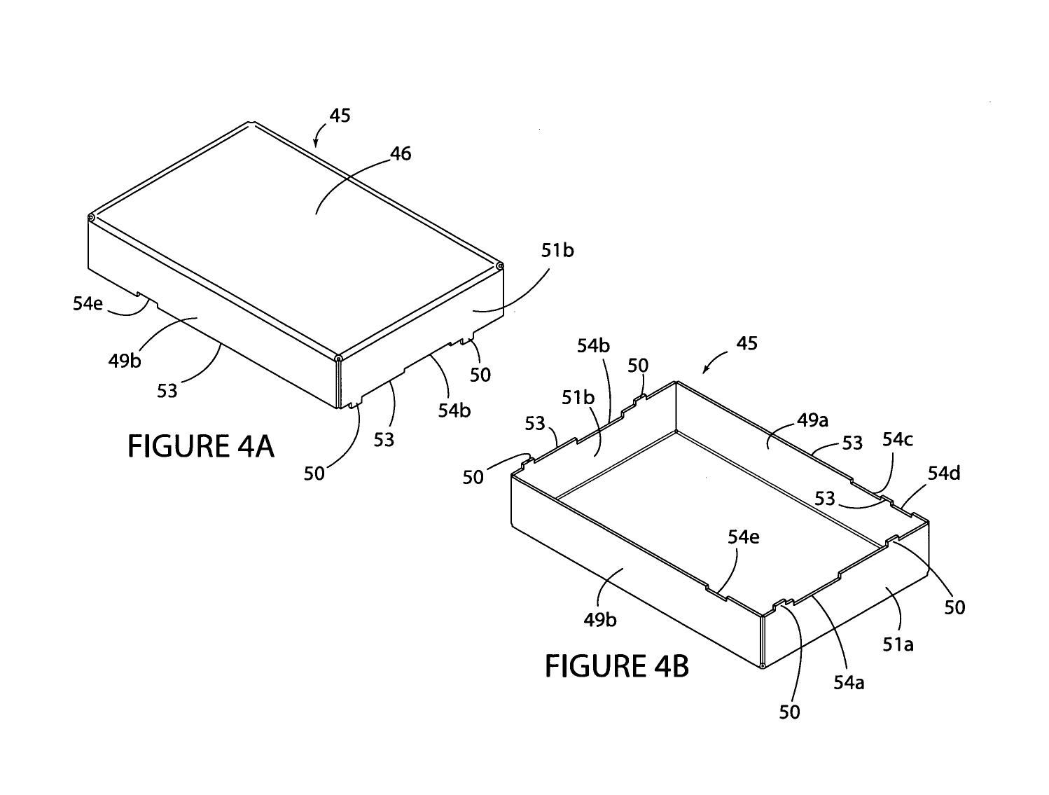

A lid 45, which is adapted to cover about two-thirds of the area of the printed circuit board 22 as described in more detail below and shown in detail in FIGS. 4A and 4B, is preferably brass with a Cu/Ni/Sn (copper/nickel/tin) plated material for ROHS compliance purposes. The area of the top of the board 22 located above copper line or strip 47 defines the portion of board 22 adapted to be covered by the lid 45 as described in more detail below. The lid 45 is adapted to act both as a dust cover and a Faraday shield.

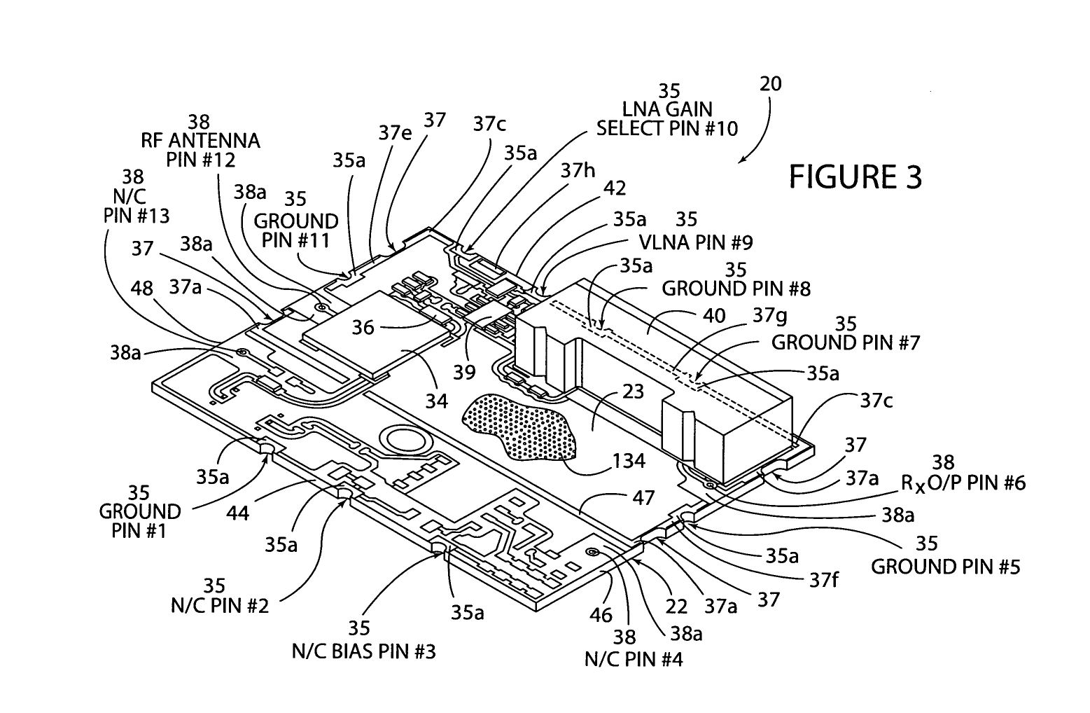

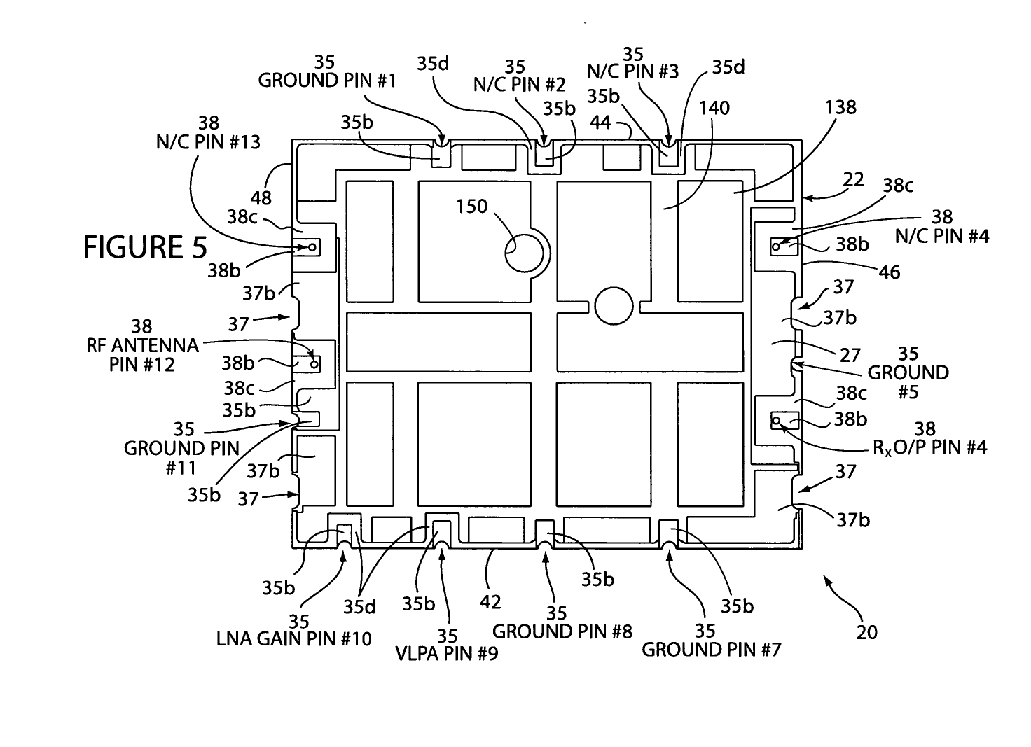

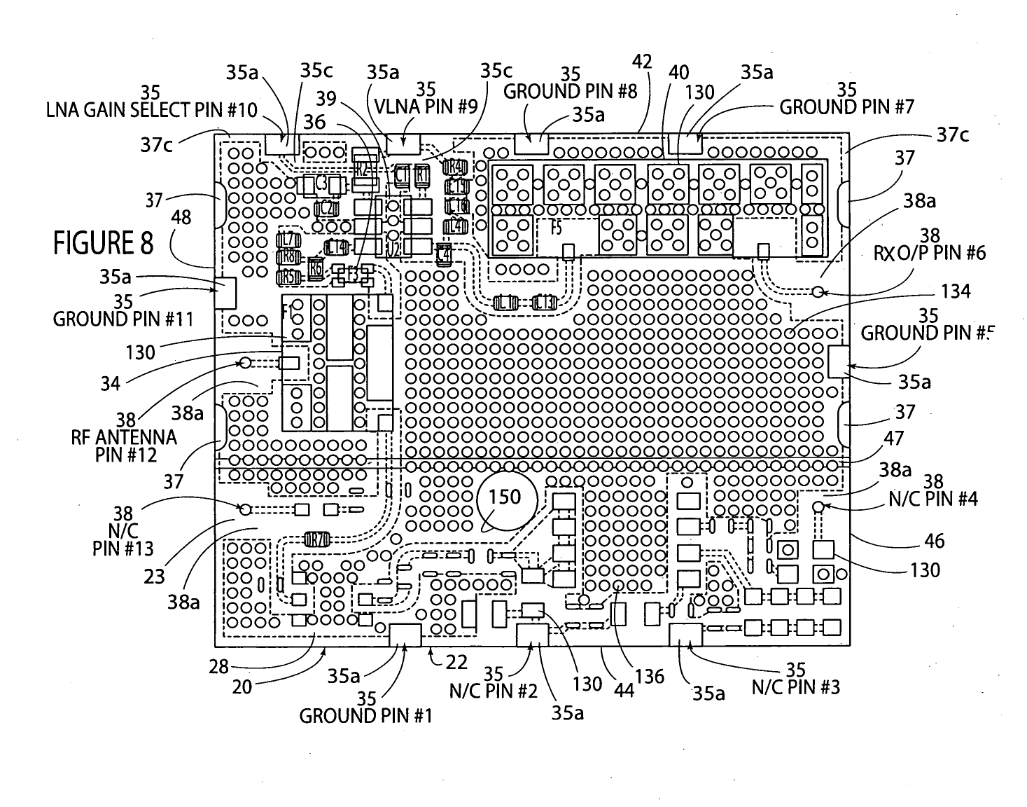

Generally rectangularly-shaped substrate 22 has a top or upper surface 23 (FIGS. 3 and 8), a bottom or lower surface 27 (FIG. 5) and an outer peripheral circumferential edge defining upper and lower faces or edges 42 and 44 and side faces or edges 46 and 48 (FIGS. 3 and 5). Although not described in any detail, it is understood that, in a preferred embodiment, substrate 22 is comprised of a plurality of stacked laminate layers of suitable dielectric material sandwiched between respective layers of conductive material as is known in the art such as, for example, a bottom RF ground plane layer, an RF intermediate signal layer, a top RF ground layer, and a topmost DC layer plus ground layer.

Castellations 35 and 37 are defined and located about the outer peripheral edge of board 22. Castellations 35 define the various ground and DC input/output pins of the module 20, while slots or castellations 37 are adapted to receive the tabs of the lid 45 as described in more detail below.

Module 20 defines a total of thirteen pins whose symbols and functions are summarized in Table E below:

TABLE E

| PIN # | SYMBOL | FUNCTION |
|---|---|---|
| 1 | GND | Ground |
| 2 | N/C | No Connection |
| 3 | N/C | No Connection |
| 4 | N/C | No Connection |
| 5 | GND | Ground |
| 6 | Rx O/P | Receive Signal Output |
| 7 | GND | Ground |
| 8 | GND | Ground |
| 9 | VLNA | LNA Supply Voltage |
| 10 | LNA Gain Select | LNA Gain Select |
| | | V < 0.8 V = high gain |
| | | V > 1.8 V = low gain (bypass mode) |
| 11 | GND | Ground |
| 12 | Antenna | Antenna Connection to Duplexer |
| 13 | N/C | No Connection |

Castellations 35 are defined by metallized semicircular grooves which have been carved out of the respective edges 42, 44, 46 and 48 and extend between the respective top and bottom surfaces 23 and 27 of the substrate 22. In the embodiment shown, the castellations 35 are defined by plated through-holes which have been cut in half during manufacturing of the substrates from an array. Castellations 35 extend along the length of the respective edges of substrate 22 in spaced-apart and parallel relationship. In the embodiment as shown in FIGS. 3 and 8, the top edge 42 defines four spaced-apart castellations 35, the lower edge 44 defines three spaced-apart castellations 35, and the side edges 46 and 48 each define one castellation 35.

Each of the side edges 46 and 48 defines a pair of spaced-apart metallized castellations 37 which are diametrically opposed from one another. Each castellation 37 is defined by an extended or elongated oval-shaped groove which has been carved out of each of the respective substrate side edges 46 and 48 respectively. All of the castellations are located above copper line or strip 47.

The outer surface of each of the respective castellations 35 and 37 is coated as by electroplating or the like, with a layer of copper or the like conductive material which is initially applied to all of the surfaces of the substrate 22 during the manufacturing of the substrate 22 as is known in the art and then removed from selected portions of the surfaces to define the copper coated castellations 35 and 37. Castellations 35 and 37 and, more specifically, the copper thereon creates an electrical path between top surface 23 and bottom surface 27 of substrate 22.

Castellations 37 can be connected to ground. The copper extends around both the top and bottom edges of each of the castellations 35 so as to define a strip or pad of copper or the like conductive material 35a on the top surface 23 of substrate 22 and surrounding the top edge of each of the respective castellations 35 (FIGS. 3 and 8); and a plurality of generally rectangularly-shaped strips 35b extending inwardly from the bottom edge of each of the castellations 35 so as to define a plurality of pads formed on the bottom surface 27 of substrate 22 (FIG. 5).

All of the pads and castellations defined on the lower surface 27 of substrate 22 allow the module 20 to be directly surface mounted by reflow soldering or the like, to corresponding pads located on the surface of the motherboard of the picocell (not shown). All of the pads and castellations create the appropriate electrical paths between the top and bottom board surfaces.

In accordance with the present invention, the pads 35a and 35b of castellations 35 defining pin #s 9 and 10 as described in more detail below are not ground pins and thus are surrounded by regions 35c (FIG. 8) and 35d (FIG. 5) respectively of the top and bottom surfaces of the substrate 22 which are not covered with copper or the like material, i.e., regions of substrate dielectric material.

Each of the castellations 37 additionally defines strips or pads 37a (FIGS. 3) and 37b (FIG. 5) of copper or the like conductive material that are formed on the top and bottom surfaces 23 and 27 respectively of substrate 22 and surround the top and bottom peripheral edges respectively of each of the respective castellations 37.

Each of the top castellations 37 additionally defines a corner strip 37c (FIG. 3) of copper or the like conductive material extending from the respective copper strips 37a surrounding respective upper castellations 37 and extending around the top corners of the board 22, while the strips 37a of the respective lower castellations 37 are connected to the ends of elongate copper strip or line 47 extending therebetween in a relationship spaced from and parallel to upper and lower board edges 42 and 44 respectively. Corner strip 37c on the left side of substrate 22 is spaced from the strip 35a of castellation 35 defining the LNA gain select pin #10.

A strip 37e (FIG. 3) of copper or the like material extends between and electrically connects the castellation 35 extending along the left side substrate edge 48 to the upper castellation 37 also extending along the left side substrate edge 48.

A strip 37f (FIG. 3) of copper or the like material extends along the right side substrate edge 46 between, and in electrical connection with, the castellation 35 defining ground pin #5 and the lower castellation 37. Still further, it is understood that an elongate strip 37g (FIG. 3) of copper or the like conductive material extends along the top substrate edge 42 between the right side corner strip 37c at one end and the castellation 35 defining the VLNA pin #9 as described in more detail below at the other end. Strip 37g is electrically connected to the corner strip 37c, the castellation 37 on the right side substrate edge 46 and the two castellations 35 extending along the top peripheral substrate edge 42 and defining ground pin #s 7 and 8 (FIG. 3) as described in more detail below.

The left side end of strip 37g, however, is spaced from the castellation 35 defining VLNA pin #9 and is thus not electrically connected thereto. Another short strip 37h (FIG. 3) of copper or the like material extends along the top peripheral substrate edge 42 between and in spaced, non-contacting, relationship with the castellation 35 defining VLNA pin #9 and the castellation 35 defining LNA gain select pin #10 also extending along the top peripheral substrate edge 42.

Each of the right and left side edges 46 and 48 additionally define and include a pair of spaced-apart conductive vias 38 which define the pin #s 4, 6, 12 and 13 of module 20 as also described in more detail below. Vias 38 are spaced from the respective edges and extend through the substrate 22 between the top and bottom surfaces 23 and 27 thereof and, as known in the art, define an interior cylindrical surface which has been plated with copper or the like conductive material. In accordance with the present invention, the use of vias 38 which are spaced from the respective substrate side edges 46 and 48 instead of castellations 35 defined in respective substrate edges 46 and 48 insures a constant 50-ohm characteristic impedance. The top openings of each of the vias 38 are surrounded by regions 38a (FIGS. 3 and 8) of dielectric substrate material, i.e., areas of the substrate 22 from which the conductive copper material has been removed as by an etching, lasing or the like process known in the art.

The lower openings of each of the vias 38 on the lower surface 27 of substrate 22 are surrounded by generally rectangularly-shaped pads 38b (FIG. 5) of copper or the like conductive material. The pads 38b in turn are surrounded by regions 38c of the lower surface 27 of substrate 22 from which the copper material has been removed as known in the art during the manufacture of substrate 22.

Thus, and as shown in FIG. 3, the castellations 35, castellations 37 and vias 38 are all positioned along each of the respective substrate side edges 46 and 48 in a spaced-apart relationship wherein one each of the castellations 35 and vias 38 is located between the pair of castellations 37 all above the copper strip 47 and wherein the lower via 38 is located below the copper strip 47. The lower vias 38 on respective side edges 46 and 48 are diametrically opposed.

Duplexer 34, Rx low pass filter 36, Rx bandpass filter 40, and Rx low noise amplifier 39 are all mounted on an area of the top surface of the board 22 above the elongate copper strip 47 and thus intended to be covered by the lid 45.

More specifically, and as shown in FIG. 3, Rx bandpass filter 40 is located in the upper right hand corner of the board 22 and extends generally longitudinally in a relationship adjacent and parallel to the top longitudinal edge 42 of board 22. Rx O/P pin #6 is located adjacent the side board edge 46 generally opposite the right end face of filter 40. Ground pin #s 7 and 8 are located along the top edge 42 in an orientation generally opposite the longitudinal top edge of filter 40.

GND (ground) pin #1, N/C (no connection) pin #2 and N/C (no connection) pin #3 (all defined by respective castellations 35) are respectively located along the lower longitudinal edge 44 of the board 22 in spaced-apart relationship from left to right.

Tx I/P (transmit input) pin #4, GND (ground) pin #5, and Rx O/P (receive output) pin #6 are respectively located along the right side elongate edge 46 of board 22 in a spaced-apart relationship from bottom to top. N/C (no connection) pin #4 is located below copper strip 47. The Rx O/P pin #6 and N/C (no connection) pin #4 are located above copper strip 47 and are defined by the respective vias 38 described above, while ground pin #5 is defined by one of the castellations 35. A castellation 37 is defined in edge 46 between strip 47 and castellation 35 defining pin #5. Another castellation 37 is defined in edge 46 between the via 38 defining the pin #6 and the top substrate edge 42.

GND (ground), GND (ground), VLNA (voltage low noise amplifier) and LNA gain select pin #s 7, 8, 9 and 10, respectively (FIG. 3) are located and extend along the top longitudinal edge 42 of board 22 in a spaced-apart relationship from right to left. Each of the pin #s 7, 8, 9, and 10 is defined by a respective castellation 35 as described above.

GND (ground), antenna, and N/C (no connection) pins #s 11, 12, and 13 respectively extend in a spaced-apart relationship along the left side edge 48 of the printed circuit board 22 from top to bottom. As described above, pin #s 12 and 13 are defined by respective vias 38, while pin #11 is defined by a castellation 35. Pin #13 is located below the copper strip 47. Pin #s 12 and 13 are located above the copper strip 47.

Pin #s 2, 3, 4, and 13 define unused/unconnected pins of the Tx path/portion of module 20.

Duplexer 34, which is preferably of a ceramic monoblock construction providing an insertion loss of about 1.3 dB on the receive side, is located and positioned on the top surface of the board 22 in a relationship generally adjacent and parallel to the left side edge 48 of board 22 and above and parallel to the copper strip 47. RF antenna pin #12 is located adjacent board edge 48 in a relationship and position generally opposite the duplexer 34.

Rx low noise amplifier 39 is located generally in the upper left hand corner of the board 22 to the left of, and spaced from, the Rx bandpass filter 40 and above and spaced from the duplexer 34 in a relationship adjacent to and spaced from the left side edge 48 of board 22. VLNA pin #9 and LNA gain select pin #10 are defined and located along the board edge 42 in a relationship and position generally above the Rx low noise amplifier 39. The Rx low noise amplifier 39 has a noise figure of 1.3 dB and a gain of 14 dB typical, or in bypass mode; 4.3 NF and −3 dB gain typical. Low noise amplifier 39 is linear and designed to work within the distributed duplexer architecture.

By way of background, it is known that a local area Node B needs to have a receive sensitivity of at least −107 dBm (12.2 Kbps) in order to meet TS25.104 R6 standard. This equates to a system noise figure of around 19 dB (actual noise figure requirements will vary according to other system impairments). A local area Node B also needs to have a higher input linearity compared to a wide area Node B. In order to meet the TS25.104 R6 standard, a system IIP3 needs to be approximately −10 dBm (a few dBs margin is added for variation in the Rx chain). However, a system IIP3 closer to 0 dB is more likely to be a typical target as deployed environments for local area Node Bs can be very harsh from an interference perspective.

Rx low pass filter 36 is located on the top surface of the board 22 generally between and below the Rx low noise amplifier 39 and above the duplexer 34, and slightly to the right of the right side edge of the amplifier 39, in a relationship spaced from and parallel to the amplifier 39 and duplexer 34 respectively. Ground pin #11 is defined in edge 48 generally opposite the filter 36. Filter 36 is adapted to reduce harmonic responses of the duplexer 34. This ensures that any spurious up to 12.75 GHz are attenuated to −30 dB or better.

The use of filters 34, 36 and 40 in combination define a distributed filtering configuration which provides the necessary “blocking” function. By way of background, it is known that one of the most challenging aspects of the UMTS standard, with respect to receiver design, is “blocking”, i.e., preventing the Tx signal from interfering with the Rx signal. In a typical radio system design, the duplexer protects the radio from “blocking” by providing out-of-band attenuation of 30 dB or better with a minimum attenuation of 20 dB from 0 Hz to 1.9 GHz, and 2.0 GHz to 12.75 GHz. This, of course, is difficult for a 60 MHz wide filter having an insertion loss typically less than 1 dB. Most duplexers that can provide this performance have eight poles and can be as large as 11 inches by 9 inches by 3 inches (28 cm×23 cm×7.6 cm). Module 20, of course, is not large enough to accommodate such a large duplexer and thus “blocking” and the required close in rejection is accomplished through the use of the three distributed filters 34, 36 and 40 described above.

Referring now to FIGS. 4A and 4B, lid 45 includes a top wall or roof 46, a pair of upper and lower walls 49a and 49b, respectively, and a pair of sidewalls 51a and 51b, respectively, depending generally perpendicularly downwardly therefrom. The walls 49a, 49b, 51a and 51b in turn define lower longitudinal edges 53. The lower longitudinal edge 53 of each of the sidewalls 51a and 51b in turn defines at least two spaced-apart tabs 50 projecting downwardly therefrom and adapted to be fitted into the respective through-slots or castellations 37 for locating and securing the lid 45 to the board 22 in a grounded relationship with the board 22 wherein the lower longitudinal edge 53 of the respective lid walls 49a, 49b, 51a and 51b are seated over copper strip 47, the copper pads 35a of castellations 35, the copper pads 37a of castellations 37, and the copper strips 37c, 37e, 37f, 37h and 37g thus providing a grounded lid 45.

The lower longitudinal edges 53 of the respective walls additionally define a plurality of discrete notches 54. Specifically, notches 54a and 54b are defined in the respective sidewalls 51a and 51b between the tabs 50. Two additional notches 54c and 54d are defined in the top wall 49a adjacent the sidewall 51a, while one additional notch 54e is defined in the lower wall 49b.

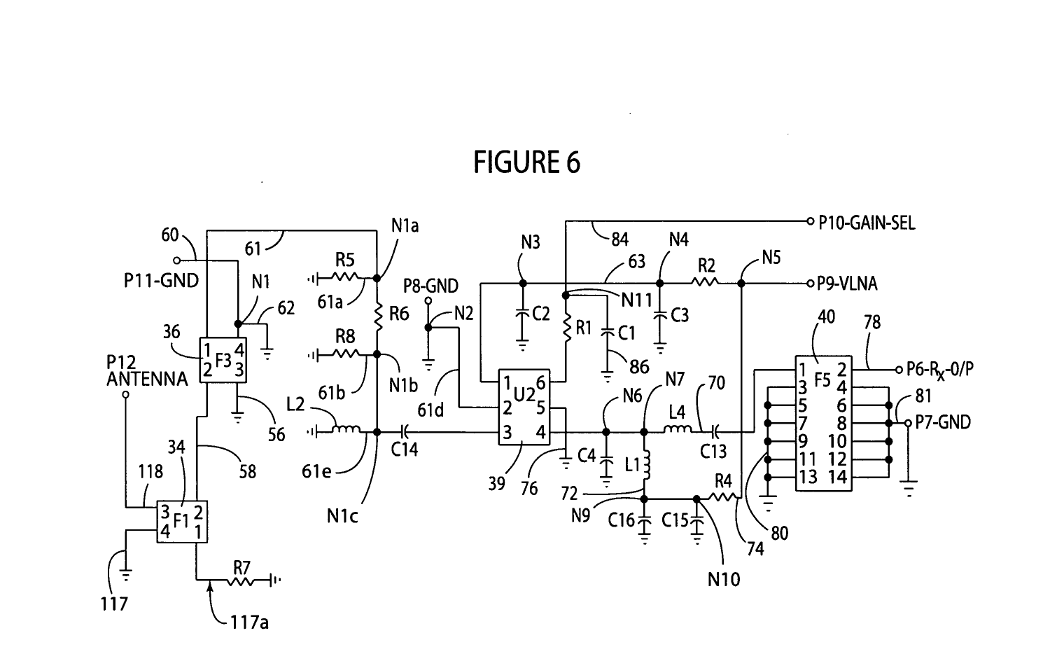

FIG. 6 is a schematic diagram of the electrical circuit of the front-end module 20. The reference and descriptions of each of the electrical components shown therein are identified in Table F below and shown in FIGS. 3, 6, and 8:

TABLE F

| Reference | Description |
|---|---|
| C1 | Capacitor |
| C2 | Capacitor |
| C3 | Capacitor |
| C4 | Capacitor |
| C13 | Capacitor |
| C14 | Capacitor |
| C15 | Capacitor |
| C16 | Capacitor |
| L1 | Inductor |
| L4 | Inductor |
| L7 | Inductor |
| R1 | Resistor |
| R2 | Resistor |
| R4 | Resistor |
| R5 | Resistor |
| R6 | Resistor |
| R7 | Resistor |
| R8 | Resistor |
| F1 | Duplexer |
| F3 | Low pass filter |
| F5 | Rx bandpass filter |
| U2 | Low noise amplifier |

The circuit of module 20 will now be described with reference to FIGS. 3, 6, and 8. Initially, and although not shown, it is understood that an Rx signal, received through the antenna and antenna pad of the motherboard of the picocell or microcell on which the module 20 is seated, is initially passed through the lower pad 38b of antenna pin #12 of module 20 up through the substrate 22 and then initially through circuit line 118 and into the input terminal #3 of duplexer 34 which is located on the top surface of the module 20. Input terminal #4 of duplexer 34 is connected to ground through a circuit line 117.

Input terminal #1 of duplexer 34 is also coupled to ground via a circuit line 117a. Resistor R7 extends along circuit line 117a between input terminal #1 and ground. This 50-ohm resistor, R7, properly terminates the unused Tx port of the duplexer 34 to ground. The Rx signal is adapted to pass through the duplexer 34 (F1) and its output terminal #2 and then through circuit line 58 and into the input terminal #2 of Rx low pass filter 36 (F3). A second circuit line 56 at the input end or ground terminal #3 of Rx low pass filter 36 connects the filter 36 to ground.

Although not described in any detail, it is understood that the term “circuit line” and/or “ground” as used herein will, in certain instances, refer to an appropriate pad or the like circuit element on the surface of the board 22.

Rx low pass filter 36 includes two output circuit lines 60 and 61 extending from output terminals #4 and #1 thereof respectively. The output line 60 connects the output terminal #4 of filter 36 to ground pin #11. Circuit line 60 is also connected to ground via circuit line 62 which is connected to circuit line 60 at node N1. Node N1 is located on circuit line 60 between the output terminal #4 of Rx low pass filter 36 and ground pin #11. The output line 61 extends between the output terminal #1 of filter 36 and the input terminal #3 of amplifier 39 (U2).

From the output terminal #1 of filter 36, the Rx signal passes through circuit line 61 and through the resistors R5, R6, and R8 comprising the optional attenuator pad 37. R6 extends along circuit line 61. R5 extends between a node N1a and ground on a circuit line 61a located above resistor R6, while resistor R8 extends on a circuit line 61b extending between node N1b and ground below resistor R6.

An inductor L7 extends on a circuit line 61c extending between a node N1c and ground below resistor R8. A capacitor C14 is located on line 61 between R6 and input terminal #3 of low noise amplifier 39. Node N1c is located on circuit line 61 between capacitor C14 and node N1b.

Low noise amplifier 39 has additional terminals #1, #2, #4, #5 and #6. Input terminal #2 of amplifier 39 is connected to ground pin #8 via node N2 on a circuit line 61d extending between input terminal #2 and ground pin #8. Input terminal #1 of amplifier 39 is connected to VLNA pin #9 via a circuit line 63. Capacitor C2 is connected between a node N3 on circuit line 63 and ground. Capacitor C3, which is connected in parallel with capacitor C2, extends between node N4 on circuit line 63 and ground. Capacitor C3 is located between capacitor C2 and VLNA pin #9. A resistor R2 is connected on circuit line 63 between node N4 and VLNA pin #9. Node N3 is located on circuit line 63 between the input terminal #1 of low noise amplifier 39 and node N4. Node N4 is located on circuit line 63 between node N3 and resistor R2. Resistor R2 is located on circuit line 63 between nodes N4 and a node N5. Node N5 is located on circuit line 63 between resistor R2 and VLNA pin #9.

Resistors R5, R6, and R8 are all located on board 22 above duplexer 34. L7, which forms part of the matching network for the low-noise amplifier 39, is located on board 22 above resistor R8. Resistors C2, C3, and C14 are all located on board 22 above R6 and to the left of amplifier 39. Resistor R2 is located on board 22 between the top substrate edge 42 and amplifier 39 and to the right of resistor C3.

Terminal #4 (i.e., the Rx signal output terminal) of low noise amplifier 39 is connected to the input terminal #1 of Rx bandpass filter 40 via a circuit line 70. A capacitor C4 is connected between a node N6 on circuit line 70 and ground. An inductor L4 and capacitor C16 are connected in series between a node N7 on circuit line 70 and ground via a circuit line 72. An inductor L1 and capacitor C13 are connected in series on circuit line 70 between the node N7 and the input terminal #1 of Rx bandpass filter 40. Additionally, a resistor R4 is coupled between a node N9 on circuit line 72 and node N5 on circuit line 63 via a circuit line 74. Node N6 is located on circuit line 70 between the output terminal #4 of low noise amplifier 39 and node N7. Inductor L1 is located on circuit line 70 between nodes N6 and N7. Node N9 is located on circuit line 72 between inductor L4 and capacitor C16. Node N5 is located on circuit line 63 between resistor R2 and VLNA pin #9.

A capacitor C15 is connected between a node N10 on circuit line 74 and ground. Node N10 is located on circuit line 74 between node N9 and resistor R4.

Output terminal #5 of low noise amplifier 39 is connected to ground via a circuit line 76.

Output terminal #6 of low noise amplifier 39 is connected to gain select pin #10 via a circuit line 84. A resistor R1 is connected on circuit line 84 between the output terminal #6 of the low noise amplifier 39 and the gain select pin #10. A capacitor C1 is connected on a circuit line 86 between a node N11 on circuit line 84 and ground. Node N11 is located on the circuit line 86 between the resistor R1 and gain select pin #10.

Capacitor C1 and resistor R1 are located on board 22 between substrate edge 42 and amplifier 39. Resistor R4, capacitors C15 and C16, inductor L4, and capacitor C4, are all located on board 22 between the right edge of amplifier 39 and the left edge of duplexer 40. Inductor L1 and capacitor C13 are both located on the board 22 below the lower left edge corner of duplexer 40.

Input terminal #s 3, 5, 7, 9, 11, and 13 of filter 40 (F5) are all connected to ground via a common circuit line. The Rx signal passes through the output terminal #2 of Rx bandpass filter 40 into the Rx output pin #6 via a circuit line 78. The output terminal #s 4, 6, 8, 10, 12, and 14 of filter 40 are all connected to ground pin #7 via a common circuit line 81.

Although not described herein in any detail, it is understood that the various copper regions and strips identified and described above have been defined and formed thereof as a result of either the subtraction or removal of selected portions of the copper material from the upper and lower surfaces 23 and 27 respectively of the substrate 22 during the substrate manufacturing process and/or as a result of the application of layers or strips of solder mask material over pre-selected portions of the copper layer as is also known in the art.

As shown in FIGS. 3, 5, and 8, it is understood that selected regions on the board 22 comprise regions of substrate dielectric material; that other selected regions on the board 22 comprise regions of the board wherein the copper material has been covered with solder mask material; and further that still other selected ones of the regions comprise regions of exposed copper material.

Selected ones of the copper connection pads, strips and regions are used to direct solder attach the terminals of the various electronic components of the module 20 of the present invention directly to the top surface 23 of the board 22 and also to direct solder attach the various terminals and pads on the lower surface 27 of the board 22 to the terminals and pads on the top surface of the motherboard of a picocell or microcell. Stated another way, selected ones of the exposed copper pads, strips and regions is adapted to have solder applied thereto as is also known in the art.

More particularly, and although not shown, it is understood that printed circuit board 22 has a plurality of differently sized and shaped connection copper pads (not shown) located below the Rx bandpass filter 40, low noise amplifier 39, low pass filter 36, and duplexer 34 so as to allow the same to be direct surface solder mounted to the board 22. Differently sized and shaped copper connection pads (not shown) are also appropriately positioned below each of the resistors and capacitors comprising the circuit of module 20.

Board 22 additionally defines a first plurality of ground through-holes 134 (FIG. 8) which, as known in the art, extend between the top and bottom surfaces 23 and 27 respectively of the board 22 and are adapted to make a grounding electrical connection between the top and bottom surfaces and any intermediate metallized layers comprising the board 22. The interior surface of each of the through-holes or vias 134 is coated with a layer of copper or the like conductive material by electroplating or the like process as known in the art. The through-holes 134 are dispersed throughout the surface of the substrate 22.

Referring to FIG. 5, it is understood that the lower surface 27 of substrate 22 additionally defines a plurality of generally rectangularly-shaped copper pads 138. The copper pads 138 are separated by strips 140 of solder mask material.

Board 22 still further defines at least one aperture 150 defining a through-way for a screw or the like (not shown) adapted to allow the module 20 to be secured to the heat sink and a customer's motherboard to allow better thermal contact between the motherboard and module 20. In the current embodiment, aperture 150 is located below copper strip 47 and to the left of power amplifier 26.

The process for assembling a module 20 involves the following steps. After the substrate/board 22 has been fabricated, i.e., once all of the appropriate copper castellations, copper strips, copper vias, copper pads, and copper through-holes have been formed thereon, and as described above, Ag/Sn (silver/tin) solder is screen printed onto a 2.6″ by 4.6″ printed circuit board array and, more particularly, onto the surface of each of the appropriate solder pads and strips defined on the array following the application of predetermined layers and strips of solder mask material as known in the art. Solder is applied to the surface of all of the designated copper strips, pads and regions and all of the electrical components including all of the filters defining the module 20 are then appropriately placed and located on the array.

The lid 45 is then placed over the appropriate portion of the board 22 as described above into a soldered coupled relationship wherein the tabs 50 thereof are fitted into the appropriate castellations/slots 37 defined in the respective side edges 46 and 48 of board 22 thereby appropriately locating and securing the lid 45 to the board 22 in a relationship where the lower edge of the lower wall 49b of lid 45 is seated over the copper strip defining line 47, the lower edge of the upper wall 49a extends along and adjacent to top board edge 42 and over the respective copper strips and pads 35a, 37c, 37g, and 37h as described above defined thereon, and the lower edges of the respective sidewalls 51a and 51b of lid 45 are seated over the respective copper strips and pads 35a, 37a, 37c and 37e extending along respective opposed board edges 46 and 48. This placement of the lid 45 into contact with pre-selected areas of the copper strips and pads on the substrate/board 22, of course, defines a module 20 where the lid 45 is electrically grounded.

It is further understood that the notches 54 defined in the lower peripheral edge of the walls 49 and 51 of lid 45 are adapted to provide a continuous grounding surface around the lid 45, while at the same time providing a gap between the lid 45 and those selected portions of the board 22 comprising exposed dielectric material or solder mask material such as, for example, the notches 54a and 54b overlying the respective vias 38 defining the antenna pin #12 and the Rx output pin #6, the notches 54c and 54d overlying the regions surrounding pins #8 and #9, and the notch 54e which overlies selected circuit lines, i.e., regions not intended to be grounded. The module 20 is then reflow soldered at a maximum temperature of 260° C. so as to couple all of the components and lid 45 to the board.

Finally, the array is then diced up as is known in the art and the individual modules 20 are then final tested and subsequently “taped and reeled” and readied for shipment.

While the invention has been taught with specific reference to an embodiment of the module adapted for use on the front end of a picocell, it is understood that someone skilled in the art will recognize that changes can be made in form and detail without departing from the spirit and the scope of the invention as defined in the appended claims. The described embodiment is to be considered in all respects only as illustrative and not restrictive.

It is understood, for example, that the invention encompasses at least the following non-exclusive illustrative embodiments: the described embodiment in which the Rx module 20 is used as a replacement for the discrete Rx components now typically being used in the Node B local area front end Rx path; an alternate embodiment in which the Rx module 20 is used in addition to, i.e., complementarily with, the discrete Rx components now typically being used in the Node B local area front end Rx path to provide a second dual Rx path for dual Rx diversity purposes; a further embodiment where the Rx module 20 is used in combination with the front end module described in pending U.S. patent application Ser. No. 11/452,800 filed on Jun. 14, 2006 to provide a second dual Rx path for dual Rx diversity operation; and a still further embodiment in which each of the RF components of the Rx module 20 have been incorporated into the RF front end module described in pending U.S. patent application Ser. No. 11/452,800 filed on Jun. 14, 2006 also for the purpose of providing dual Rx diversity operation.

It is still further understood that, in those applications where limited space on the motherboard is a factor, the present invention encompasses the embodiment wherein the module 20 has been manufactured such that it does not include the portion of the printed circuit board 22 extending below the copper strip 47 and comprising and defining the unused/unconnected Tx (transmit) section of module 20. In such embodiment, the lower board edge 42 would be located adjacent the strip 47.

What is claimed is:

1. An RF module adapted for direct surface mounting to a front end of a motherboard of a picocell or microcell, said module including a printed circuit board having a plurality of discrete electrical components mounted to a surface thereof and adapted to allow for the reception of cellular signals between the antenna of said picocell or microcell on one end and the respective output pad on said motherboard of said picocell or microcell at the other end.

2. The RF module of claim 1 comprising at least a duplexer, a receive bandpass filter and a low pass filter all direct surface mounted to the surface of said printed circuit board of said module.

3. The RF module of claim 2 further comprising a low-noise amplifier direct surface mounted to the surface of said printed circuit board of said module.

4. The RF module of claim 3 wherein said duplexer, said receive low pass filter, said low-noise amplifier, and said receive bandpass filter define a receive path for RF signals.

5. The RF module of claim 4 further comprising an attenuator pad in said receive path between said receive low pass filter and said low-noise amplifier.

6. The RF module of claim 4 further comprising a lid adapted to cover at least said duplexer, said low-noise amplifier, and said receive bandpass filter.

7. An RF module adapted for direct surface mounting to a front end of a motherboard of a picocellular or microcellular base station and adapted to receive RF signals, the module comprising a circuit board including at least the following discrete electrical components mounted to a surface thereof: a duplexer, a receive low pass filter, a low-noise amplifier, and a receive bandpass filter.

8. The RF module of claim 7, wherein the RF signals are adapted to pass successively through said duplexer, said receive low pass filter, said low-noise amplifier, and said receive bandpass filter.

9. The RF module of claim 7, wherein said duplexer, said receive bandpass filter, said receive low pass filter, and said low-noise amplifier are all located under a lid attached to the surface of the printed circuit board.

10. The RF module of claim 7, wherein said printed circuit board has a bottom surface having a plurality of electrically conductive pads formed thereon and adapted to allow said printed circuit board to be direct surface mounted to the motherboard of the picocell.

11. An RF module adapted for direct-surface mounting to the front end of the motherboard of a picocell, the module comprising:
a substrate including top and bottom surfaces, the top surface defining a plurality of electrically conductive connection pads, circuit lines, and pins and the bottom surface defining a plurality of electrically conductive connection pads for mounting said module directly to the top surface of the motherboard of the picocell; and
a section on said substrate defining a receive path for RF signals and including at least the following discrete electrical components direct surface mounted to the top surface thereof: a duplexer, a receive low pass filter, a low-noise amplifier, and a receive bandpass filter.

12. The RF module of claim 11 further comprising a lid attached to the top surface of the substrate and adapted to cover at least said duplexer, said receive bandpass filter, said receive low pass filter, and said low-noise amplifier.
